(19) United States
(12) Patent Application Publication
(10) Pub. No.: US 2005/0169730 A1
(43) Pub. Date: Aug. 4, 2005

(54) Semiconductor processing tool front end interface with sealing capability

(76) Inventors: Ravinder Aggarwal, Gilbert, AZ (US); James F. Kusbel, Scottsdale, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/834,577

(22) Filed: Apr. 29, 2004

Related U.S. Application Data
(60) Provisional application No. 60/467,237, filed on Apr. 30, 2003.

(51) Int. Cl. B65G 1/00

(52) U.S. Cl. 414/217; 414/416.01

(57) ABSTRACT

A sealing member provides a seal between a front opening unified pod (FOUP) and a semiconductor processing tool. The seal inhibits fluid flow between an ambient environment and a minienvironment in a front end of the processing tool while the FOUP and minienvironment are open to one another for transporting wafers between the processing tool and the FOUP.

### RELATED APPLICATIONS

This application claims the priority benefit under 35 U.S.C. § 119(e) of the provisional application 60/467,237, filed Apr. 30, 2003, which is hereby incorporated by reference in its entirety.

### FIELD OF THE INVENTION

The present invention relates to protecting wafers from native oxide and contamination while awaiting processing or transport.

### BACKGROUND OF THE INVENTION

Semiconductor wafers and other substrates are typically subjected to a series of processes in various processing tools. After the wafers have undergone a process in one tool, they may have to be transported to another tool to undergo a subsequent process. For example, wafers that have been subjected to a process such as chemical vapor deposition in one tool may have to be transported to another tool to be cleaned and dried, and then to another tool for further processing.

It is important that the wafers be kept isolated from particulate contamination during transport from one processing tool to another. One means of reducing contamination is by transporting the wafers in closed cassettes, such as front opening unified pods (FOUP).

FOUPs containing wafers are transported to a loading port at a front end of a processing tool. A door opener at the loading port opens the door of the FOUP to allow a wafer robot in the front end of the tool to access the wafers. The robot removes the individual wafers for processing and then returns them to their slots in the FOUP. Depending on a number of factors, such as the size of a production run, cycle time, etc, wafers may sit in a FOUP for a substantial length of time between processing steps. During this time, it is possible for oxygen and moisture to leak into the FOUP. Unfortunately, moisture and oxygen have detrimental effects on the surfaces of semiconductor wafers, and thus it is desirable to minimize the exposure of the wafers to these elements. When all of wafers have been processed and returned to the FOUP, the FOUP door is closed.

The Semiconductor Equipment Materials International Standards Program (document SEMI E19) dictates that a small gap be left between the FOUP and the loading port of the processing tool when the FOUP is in place at the loading port. While intended to provide for interchangeability between manufacturers, this also allows gases to leak through the gap between the FOUP and the loading port.

In some processes, such as low temperature epitaxial deposition, it is desirable to place the wafers in an inert environment as soon as possible after they arrive at the processing tool. In the case of epitaxial deposition processes, for example, this minimizes the exposure of the wafers to oxygen and thus limits oxide growth on the surfaces of the wafer, such that high temperature bake steps for subliming native oxide can be omitted. Typically, this is accomplished by maintaining a nitrogen minienvironment in the front end of the processing tool with a slight overpressure. The intent is that, when the door of the FOUP is opened, nitrogen flows from the front end of the processing tool and into the FOUP. Because of the gap between the loading port and the front of the FOUP, however, the nitrogen leaks through the gap, thereby increasing the amount of time necessary to purge the FOUP, making it difficult to maintain an overpressure in the front end of the tool and allowing a leakage path for contamination. Even if pressed against the interface of the front end without a gap, the standard FOUP will tend to allow leakage, especially when the front end is kept at an overpressure.

### SUMMARY OF THE INVENTION

In accordance with one aspect of the invention, a semiconductor processing apparatus comprises a front end part and a seal. The front end part has an interface portion for interfacing with a closeable wafer cassette. The seal is to seal the interface portion against the wafer cassette. In one embodiment, the seal is an inflatable bladder. In another embodiment, the seal is a closed-cell foam material. Preferably, the seal is a hermetic or generally air tight seal to prevent fluid from passing between the interior portion of the closeable wafer cassette and the environment surrounding the closeable wafer cassette.

In one embodiment, a semiconductor processing apparatus comprises a front end part and a sealing member. The front end part has an interface opening for interfacing with a closeable wafer cassette. The sealing member is configured to seal the wafer cassette with the interface opening and to deform to form a seal between the wafer cassette and the interface opening.

In another embodiment, a method is provided for processing semiconductor wafers. The method comprises moving a front opening unified pod (FOUP) into position at a front end of a wafer processing apparatus. A seal is formed between a pliant member and one of the FOUP and a front end of the wafer processing apparatus. The pliant member is attached to the other one of the FOUP and the front end of the processing apparatus.

In another embodiment, a semiconductor processing apparatus comprises a front end part and compressible member. The front end part has an interface opening for interfacing with a wafer cassette. The interface opening has an interface surface that surrounds the interface opening. The compressible member is configured to mate with the interface opening and a portion of the wafer cassette. The wafer cassette defines an opening for passing wafers therethrough. The compressible member is configured to substantially deform to form a seal between the wafer cassette and the interface opening. In one arrangement, the substantial deformation is a recess region that is formed in the compressible member.

In another embodiment, a method is provided for processing semiconductor wafers. The method comprises moving a wafer cassette into position at a front end of a wafer processing apparatus. The wafer cassette has a contact surface. A seal is formed between the wafer cassette and the front end by fitting the contact surface of the wafer cassette into a sealing recess on the front end of the wafer processing apparatus.

In another embodiment, a semiconductor processing apparatus comprises a front end part and a sealing recess. The front end part has an interface opening for interfacing with a closeable wafer cassette. The sealing recess on the front end part is adapted to receive a portion of the wafer cassette to seal the wafer cassette with the interface opening.

In accordance with another aspect of the invention, semiconductor wafers are processed by moving a front opening unified pod (FOUP) into position at a front end of a wafer processing apparatus, and sealing the FOUP against the front end of the processing apparatus. In one embodiment, sealing comprises contacting the wafer pod with an inflatable bladder seal of the apparatus. In another embodiment, sealing comprises contacting the wafer pod with a closed-cell foam seal of the apparatus.

These and other aspects of the present invention will become readily apparent to those skilled in the art from the appended claims and from the following detailed description of the preferred embodiments having reference to the attached figures, the invention not being limited to any particular preferred embodiment(s) disclosed.

### BRIEF DESCRIPTION OF THE DRAWINGS

FIG. 1A is a perspective top, left and front view of a standard FOUP with a front door removed and loaded with wafers;

FIG. 1B is a bottom, right and front view of the FOUP of FIG. 1A without the wafers;

FIG. 2 is a front view of the FOUP of FIGS. 1A and 1B shown with a front door attached;

FIG. 3 is a schematic top view of two FOUPs at a front end part of a semiconductor processing tool;

FIG. 4 is a schematic front view of a processing tool and a sealing member around an interface opening;

FIG. 5A is a schematic cross-sectional side view taken along line 5-5 of FIG. 3 of an opened FOUP at the front end interface of a semiconductor processing tool, with a sealing member surrounding the interface opening and attached to the processing tool in accordance with a preferred embodiment of the present invention;

FIG. 5B is a schematic cross-sectional side view taken along line 5-5 of FIG. 3 of an opened FOUP at the front end interface of a semiconductor processing tool, with another embodiment of a sealing member surrounding the interface opening; and

FIG. 5C is an enlarged sectional view taken along 5C-5C of FIG. 5A.

### DETAILED DESCRIPTION OF THE PREFERRED EMBODIMENTS

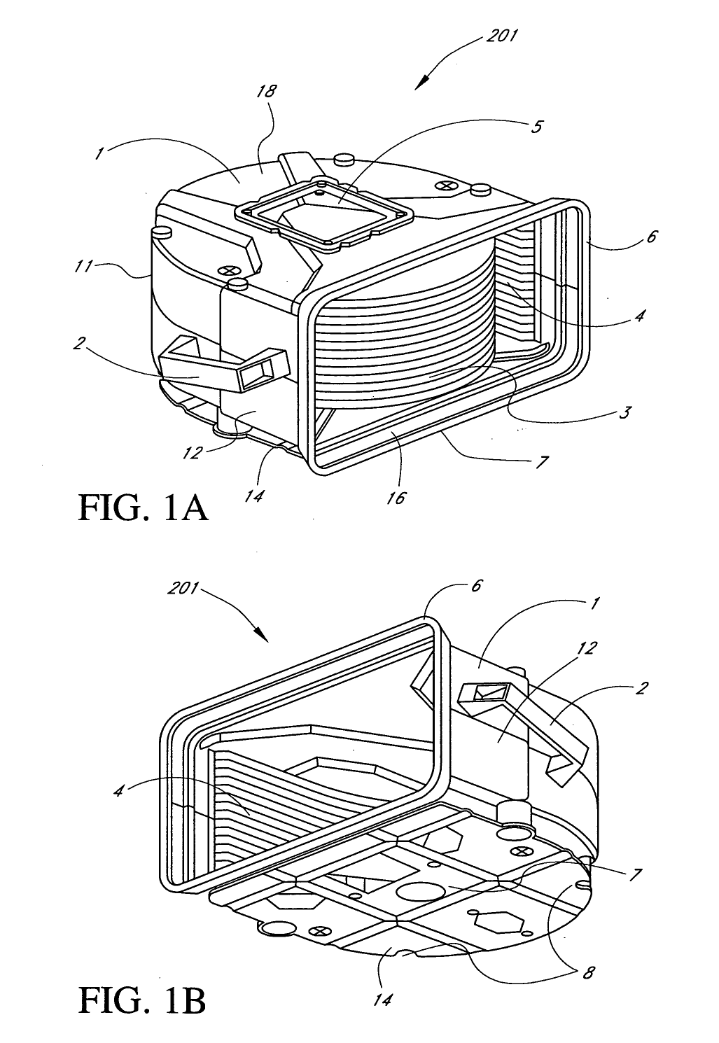

During transport and storage in a fabrication facility, wafers are contained inside a front-opening unified pod (FOUP) carrier 201, shown in FIG. 1A with the door removed. The FOUP 201 includes spaced shelves 4 for holding wafers 3 (FIG. 1A), similar to a standard open wafer cassette, as well as a door (removed in FIG. 1A) for closing the FOUP during transport. The FOUP has a standard mechanical interface (SMIF) for connecting with process tools. The FOUP isolates the wafers from ambient particulate and molecular contamination, while also providing accurate wafer positioning. The Semiconductor Equipment Materials International Standards Program (document SEMI E47.1) describes specifications for boxes and pods used to transport and store 300-mm wafers and is hereby incorporated herein by reference.

With reference to FIGS. 1A and 1B, a box shell 1 of the FOUP 201 (described in SEMI E47.1-0997) is fitted with handles 2 for transporting the FOUP 201 manually. The box shell 1 has side walls 12 and a rear wall 11, each extending between a top 18 and a bottom 14. The box shell 1 has an opening 16, which is generally rectangular, opposite the rear wall 11. Inside, the wafers 3 are held spaced apart in a stack and supported by either shelves 4 coupled to the side walls 12 or slots formed in a plurality of columns. The top of the FOUP has a handling flange 5 that can be engaged by a robot (not shown) to move the FOUP. On the bottom side of the FOUP, there is a coupling plate 7 (described in SEMI E47.1-0997) that contains recess pockets 8 to facilitate transport and self-locating placement of the FOUP. The FOUP 201 has a contact surface 6 around the opening 16.

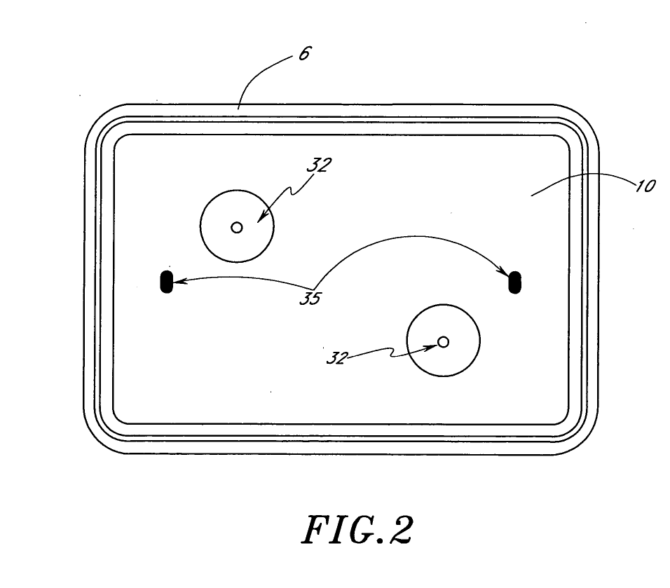

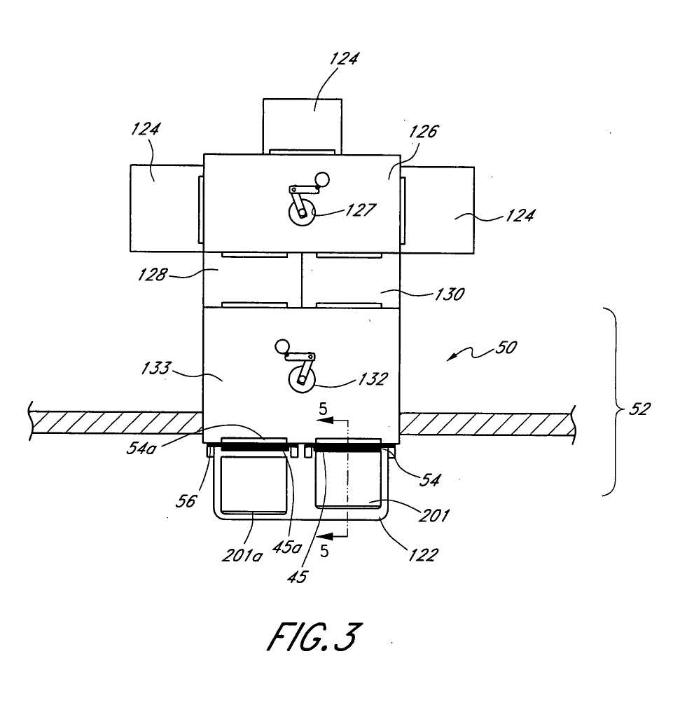

The FOUP 201 also comprises a removable door 10 as illustrated in FIG. 2. The door generally includes registration pins 32 and a pair of key slots 35 configured to lock and unlock the door 10. A processing tool 50 preferably has a door mechanism that has latch keys that can be aligned and received by the latch key slots 35. After engaging the latch keys with the latch key slots 35, the latch keys of the door mechanism can be rotated to unlock the door 10. Then the door mechanism can move the unlocked door 10 away from the FOUP 201, as described below.

FIG. 3 is a schematic top view of the FOUP 201 docked at the front end part 52 of the processing tool 50. The FOUP 201 is in contact with a sealing member 45 formed on the front end part 52, in order to form a seal between the FOUP 201 and the front end part 52, more particularly between the FOUP 201 and an interface opening 54.

A second FOUP 201a is, shown undocked at an interface opening 54a of the processing tool 50, such that a second sealing member 45a is not in contact with the second FOUP 201a. A seal can be formed between the second FOUP 201a and the interface opening 54a by moving the second FOUP 201a to contact the sealing member 45a. The FOUP 201 and the second FOUP 201a are resting on a front end interface (FEI) load platform 122. The processing tool 50 includes a plurality of process chambers 124, a wafer handling chamber 126 housing a handling robot 127, a first load lock 128, a second load lock 130, and an atmospheric robot 132 in a front end handling chamber 133. The front end part 52 includes the loading platform 122 and a front end handling chamber 133, and defines the interface openings 54, 54a (FIG. 3), which are openings sized to allow wafers 3 (FIG. 1A) from FOUP 201 to pass into the processing tool 50.

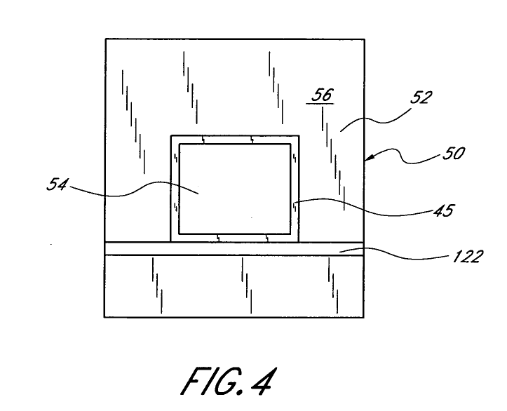

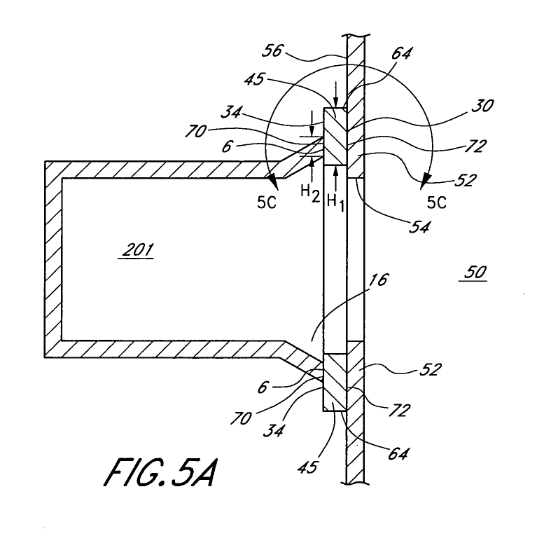

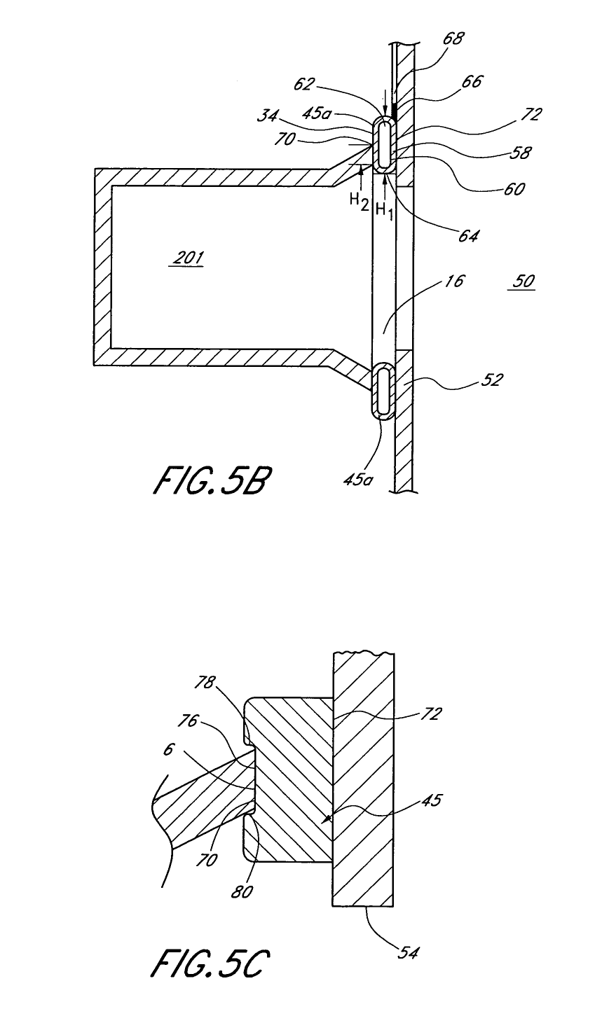

In the illustrated embodiment, the interface opening 54 is substantially rectangular in shape (FIG. 4, FOUP 201 not shown). The front end part 52 has an outer surface 56 in contact with the ambient environment and an interface surface 30 located at the periphery of the interface opening 54 as shown in FIG. 5A.

FIG. 5A is cross sectional side view of the FOUP 201 in the load/unload position. Both the door of a front end part 52 and the door of the FOUP 201 are removed, thereby allowing wafers from the FOUP 201 to pass through both the opening 16 and the interface opening 54 of the front end part 52 and into the processing tool. A seal is formed between the FOUP 201 and the front end part 52 of the processing tool, preferably a hermetic seal. In one embodiment, the seal formed between the FOUP 201 and the front end part 52 is a pliant sealing member 45 that may undergo substantial deformations while providing a bias, as discussed below. In the load/unload position, the sealing member 45 is preferably compressed by moving the FOUP 201 toward the processing tool 50 as described below. Similarly, the sealing member 45 can be uncompressed by moving the FOUP 201 away from the processing tool 50. Of course, if the FOUP 201 is moved away too far from the processing tool 50, the seal between the FOUP 201 and the processing tool 50 will be broken.

In the illustrated embodiment, the interface surface 30 is coupled to the sealing member 45, preferably by an adhesive or other coupling device. The sealing member 45 has an outer surface 64 that defines an exposed sealing surface 34, which can contact the contact surface 6 of the FOUP 201, thereby forming a seal. Preferably, the sealing surface 34 is shaped generally similar to the contact surface 6 so that the surfaces 34, 6 can be conveniently mated together. As illustrated in FIG. 1A, for example, the contact surface 6 of the FOUP 201 can define a generally rectangular opening 16, and the surface 6 is configured to mate with a similarly shaped sealing member 45. In other arrangements, it will be understood that the sealing member 45 can be provided on the FOUP's contact surface.

The sealing member 45 is positioned near the interface opening 54, but does not block the interface opening 54 as shown in FIGS. 4 and 5A, such that wafers can be passed through the openings 16, 54 in order to load/unload the FOUP 201. In the illustrated embodiment, the sealing member 45 extends continuously around the interface opening 54. The sealing member 45 can have any suitable cross-sectional profile suitable for forming a seal between the FOUP 201 and the interface opening 54. For example, the cross sectional profile of the seal member 45 can be rectangular, cylindrical, semi-circular, and the like. In one embodiment, the cross section along the sealing member 45 is substantially constant to ensure an effective seal between the contact surface 6 and the interface opening 54, which can be generally parallel to each other. In another embodiment, the cross section along the sealing member 45 can vary in size to achieve the desired seal between the contact surface 6 of the FOUP 201 and the interface opening 54, which may not be parallel.

In one embodiment, the sealing member 45 can have a height H1 that is greater than the height H2 of the contact surface 6 of the FOUP 201, as shown in FIG. 5. Advantageously, the surface area of the sealing surface 34 facing the FOUP 201 thus provides easy alignment between the FOUP 201 and the sealing member 45. Although not illustrated, the height H1 of the sealing member 45 can be equal to or less than the height H2 of the contact surface 6. Advantageously, the height H1 of the sealing member 45 provides sufficient tolerance that there is interchangeability between the FOUPs and process tools 50 produced by different manufacturers. That is, in the illustrated embodiment, the sealing member 45 can form a seal with FOUPS 201 having different sized and shaped openings 16, and thus may inhibit or prevent passing of particulate and molecular contamination between the environment surrounding the sealing member 45, FOUP 201, and the processing tool 50 and the minienvironment of the processing tool 50.

In one embodiment, the sealing member 45 is formed from a compressible material, preferably a closed-cell foam, capable of withstanding deformations with elasticity to bias against the contact surface 6. Alternatively, the sealing member 45 can be formed from open-cell foam preferably having an outer layer, which is adapted to engage the contact surface 6 of the FOUP 201 to form the seal (e.g., a seal 70). For example, the outer layer can be a smooth polymer or rubber layer surrounding a core formed from open-cell foam material. Additionally, the sealing member 45 can have a cross section that is generally rectangular (as shown in FIG. 5A), cylindrical, semi-circular, and the like, as discussed above. In one embodiment, the sealing member 45 has a generally solid cross section, i.e., the sealing member 45 is not hollow However, the sealing member 45 can have any cross section suitable for forming a seal between the FOUP 201 and the process tool 50.

A seal is formed by compressing the sealing member 45 between the contact surface 6 of the FOUP 201 and the interface surface 30 of the processing tool 50, as shown in FIGS. 5A, 5B, and 5C. A desired seal can be obtained by varying the distance between the contact surface 6 of the FOUP 201 and the interface surface 30. For example, if the seal leaks when the FOUP 201 is in the load/unload position, the FOUP 201 can be moved closer to the processing tool 50 to further compress the sealing member 45, thereby eliminating the fluid leak.

The seal can comprise several seals that are formed by the interaction between the sealing member 45 and the FOUP 201 and between and the sealing member 45 and the processing tool 50. In the illustrated embodiment of FIGS. 5A and 5B, the seal 70 is formed between the sealing surface 34 and the contact surface 6 of the FOUP 201, and a seal 72 is formed between the outer surface 64 of the sealing member 45 facing the processing tool 50 and the interface surface 30. In one embodiment, the seal 70 can be formed by pressing the FOUP 201 against the sealing member 45, which, in turn, forms a seal 72 with the interface surface 30. The seal 72 can be formed by using an adhesive to attach the outer surface 64 of the sealing member 45 to the interface surface 30. It is contemplated that any suitable means can used to couple the sealing member 45 to the processing tool 50.

As illustrated in FIG. 5C, the sealing member 45 can be squeezed between the FOUP 201 and the processing tool 50. In one embodiment, a seal recess 76 is formed in the sealing member 45 in response to the pressure applied by the FOUP 201. The seal recess 76 has a pair of lips 78, 80 formed by the upper and lower portions, respectively, of the contact surface 6. As the FOUP 201 is moved from the illustrated position towards the processing tool 50, the depth of the seal recess 76 can be increased. The surface 34 of the sealing member 45 can thus be adapted to move relative to the interface surface 30. In the illustrated embodiment, the sealing member 45 is spaced outwardly from the interface opening 54. However, the sealing member 45 can be at any suitable location for forming a seal between the FOUP 201 and the processing tool 50. For example, the sealing member 45 can be flush with the interface opening 54. Those skilled in the art recognize that the sealing member 45 may be formed of suitable pliant material like plastics, polymers, elastomers, foams, polyester, thermoplastics, silicon elastomers, thermoplastic elastomers, and the like.

In one embodiment, the seal recess 76 can be pre-formed, or permanent, to ensure that the FOUP 201 remains properly aligned with the sealing member 45. For example, the seal recess 76 can be a groove or channel formed in the sealing surface 34 that extends around the entire sealing member 45. Thus, the sealing member 45 can ensure that the desired seal is maintained between the FOUP 201 and the processing tool 50. Further, the sealing recess 76 can improve the seal between the FOUP 201 and the processing tool 50, even if the sealing member 45 is generally not pliant. For example, the seal 70 can be formed when the contact surface 6 of the FOUP 201 is disposed within the pre-formed sealing recess 76. Advantageously, the sealing recess 76 can provide an increased region of contact between the FOUP 201 and the sealing member 45. Those skilled in the art will recognize that the sealing recess 76 can have any suitable size and configuration for engaging the FOUP 201. For example, the sealing recess 76 can have a U-shape, V-shaped, or curved cross sectional profile, which is preferably sized to receive the contact surface 6 of the FOUP 201.

In operation, for example, the FOUP 201 is transported and aligned with the front end 52. The FOUP 201 is then moved towards the processing tool 50 until the contact surface 6 of the FOUP 201 contacts the sealing member 45. That is, if the FOUP 201 is in the load/unload position and there is an undesired fluid flow between the ambient environment and the minienvironment of the front end handling chamber 133 (typical purged to a slight over-pressure), the FOUP 201 can be moved towards the processing tool 50 to compress the sealing member 45 between the contact surface 6 of the FOUP 201 and the front end part 52 to achieve desired seals between the FOUP 201 and the front end 52. Those skilled in the art will recognize that a desired seal can be obtained by varying the distance between the FOUP 201 and the processing tool 50.

The FOUP 201 with the door 10 attached is transported to the front end part 52 of the processing tool 50. The FOUP 201 is moved to the load/unload position so that the sealing member 45, as described above, forms a seal between the FOUP 201 and the processing tool 50. Then the door mechanism of the front end part 52 unlocks and opens the door 10 of the FOUP 201. The seal, preferably an air tight seal, between the FOUP 201 and the processing tool 50 while the door 10 unlocked and removed. Alternatively, the door mechanism of the front end part 52 can unlock and open the door 10 of the FOUP 201 when the FOUP 201 is not contacting the sealing member 45. After the door 10 is removed, the FOUP 201 can be moved to the load/unload position so that the sealing member 45 forms a seal between the FOUP 201 and the processing tool 50. Thus, the seal between the FOUP 201 and the processing tool 50 can be formed at various times during the process.

The atmospheric robot 132 of the processing tool 50 removes individual wafers for processing. If the processing tool is maintained at a higher pressure than the ambient pressure in the clean room, the seal prevents leakage of fluid from the FOUP 201 and the front end part 52 into the clean room. For example, during low temperature epitaxial deposition, a nitrogen minienvironment in the front end of the processing tool 50 can be maintained with a slight overpressure without breaching the integrity of the seal. Thus, ambient air from the clean room does not diminish the integrity of the nitrogen minienvironment. The nitrogen environment minimizes the wafers' exposure to oxygen, thereby limiting oxide growth on the wafers 3. After the wafers 3 are processed, the atmospheric robot 132 returns the wafers to the shelves 4 in the FOUP 201 or to a different cassette. When all wafers have been processed and put in the FOUP 201, the door mechanism closes the FOUP by attaching and locking door 10. The FOUP 201 is then transported away from the front end part 52. Thus another FOUP can be transported to the front end part 52, and the process can be repeated.

FIG. 5B is a cross sectional side view of the FOUP 201 in the load/unload position and engaging with another embodiment of the sealing member. In the illustrated embodiment, the sealing member 45a can be selectively operated to form a seal between the FOUP 201 and the front end part 52. In one embodiment, the sealing member 45a is an expandable sealing member (e.g., a bladder seal) having a wall 58, a fluid chamber 62, and an optional intake valve 66. The seal between the FOUP 201 and the processing tool 50 can be formed by adjusting the amount of fluid in a fluid chamber 62 and the distance between the contact surface 6 and the interface surface 30.

The wall 58 can have an inner surface 60 that defines the fluid chamber 62 and the outer surface 64. The wall 58 can comprise a polymer material (e.g., rubber or plastic) or any suitable material for forming the expandable sealing member 45a to provide a desired seal between the FOUP 201 and the front end part 52. That is, the sealing member 45a is formed from a material that can contain a pressurized fluid. Thus, those skilled in the art recognize that the sealing member 45a may be formed of suitable pliant material like plastics, polymers, elastomers, foams, polyester, thermoplastics, silicon elastomers, thermoplastic elastomers, and the like.

The sealing member 45a preferably has an intake valve 66 that is in fluid communication with a fluid source (not shown) via a fluid line 68. The intake valve 66 can be in fluid communication with one or more controllers or switches that can control the amount of fluid in the sealing member 45a. The sealing member 45a can be inflated by filling the chamber 62 of the sealing member 45a with fluid from the fluid source, such as an air line. The inflated sealing member 45a can form a seal between the FOUP 201 and the processing tool 50. The sealing member 45a can be deflated by having fluid within the chamber 62 pass through and out of the valve 66 or a separate outlet valve (not shown). Thus, fluid and be added or removed from the chamber 62 to achieve the desired inflation of the sealing member 45a. Optionally, the sealing member 45a can have a plurality of chambers 62 for inflating the sealing member 45a. For example, the sealing member 45a can have a plurality of generally tubular chambers 62 that are parallel to each other. Each of the chambers 62 can be in fluid communication with the fluid source in order to inflate and deflate the sealing member 45a as desired.

A recess region similar to the seal recess 76 can be formed in the sealing member 45a by the FOUP 201. That is, the FOUP 201 can contact the sealing member 45a and deforms the sealing member 45a, thereby forming the recess region. Further, the seal recess can be pre-formed, or permanent, to ensure that the FOUP 201 remains properly aligned with the sealing member 45a. For example, the seal recess 76 can be a groove or channel formed in the sealing surface 34 that extends around the entire sealing member 45a. Additionally, the other types of bladder seals can be used to form the desired seal between the FOUP 201 and the process tool 50.

In operation, for example, the FOUP 201 is transported and aligned with the front end 52. The FOUP 201 is then moved towards the processing tool 50 until the contact surface 6 of the FOUP 201 contacts or is close to the sealing member 45a. The sealing member 45a is inflated, causing the contact surface 6 of FOUP 201 to contact the sealing member 45a. The pressure in the sealing member 45a can be varied until the desired seal is formed between the FOUP 201 and the sealing member 45a. That is, if the FOUP 201 is in the load/unload position and there is an undesired fluid flow between the ambient environment and the minienvironment of the front end handling chamber 133 (typical purged to a slight over-pressure), the sealing member 45a can be inflated thereby inhibiting that undesired fluid flow. Those skilled in the art recognize that a desired seal can be obtained by varying the distance between the FOUP 201 and the processing tool 50 and/or the fluid pressure in the sealing member 45a. Alternatively, the sealing member 45a can be at least partially inflated when the FOUP 201 is brought into contact with the sealing member 45a. The sealing member 45a can then be inflated and/or deflated to achieve the desired seal between the FOUP 201 and the process tool 50.

The FOUP 201 with the door 10 attached is transported to the front end part 52 of the processing tool 50. The FOUP 201 is moved to the load/unload position so that the sealing member 45a, as described above, forms a seal between the FOUP 201 and the processing tool 50. Then the door mechanism of the front end part 52 unlocks and opens the door 10 of the FOUP 201 so that the wafers in the FOUP 201 can be processed, as described above. Of course, the door 10 of the FOUP 201 can be unlocked and removed before the seal is formed between the FOUP 201 and the front end part 52.

In an alternative embodiment, the sealing member (e.g., sealing member 45) is attached to the contact surface 6 of the FOUP 201, such that the FOUP 201 and sealing member 45 form an integral body. The FOUP 201 is positioned so that the sealing member contacts or is close to the front end 52. The sealing member 45 is preferably formed from closed-cell foam material that can be pressed against the interface surface 30 to form the seal 72. The FOUP 201 can be moved away from or toward the processing tool 50 to adjust the pressure applied to the sealing member 45. In this manner, the force applied the sealing member 45 can be varied until the desired seal is formed between the FOUP 201 and the sealing member 45, as discussed above.

It should be noted that certain objects and advantages of the invention have been described above for the purpose of describing the invention and the advantages achieved over the prior art. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

1. A semiconductor processing apparatus, comprising:
a front end part having an interface opening for interfacing with a closeable wafer cassette; and
a sealing member to seal the wafer cassette with the interface opening, the sealing member configured to deform to form a seal between the wafer cassette and the interface opening.

2. The apparatus of claim 1, wherein the closeable wafer cassette has a contact surface that defines a cassette opening through which wafers can be passed, and the sealing member is configured to engage with the contact surface to form a seal recess in the sealing member, the seal recess and contact surface forming a fluid inhibiting seal.

3. The apparatus of claim 1, wherein the sealing member comprises an inflatable bladder.

4. The apparatus of claim 1, wherein the sealing member comprises a closed-cell foam material.

5. The apparatus of claim 1, wherein the sealing member is attached to the front end part surrounding the interface opening thereof.

6. The apparatus of claim 5, wherein the front end part comprises an interface surface surrounding the interface opening, the sealing member protrudes from the interface surface and has an exposed surface configured to mate with at least a portion of the wafer cassette that defines a wafer cassette opening, through which wafers can be passed.

7. The apparatus of claim 6, wherein the exposed surface has generally the same shape as the portion of the wafer cassette defining the wafer cassette opening.

8. A method of processing semiconductor wafers, comprising:
moving a front opening unified pod (FOUP) into position at a front end of a wafer processing apparatus; and
forming a seal between a pliant member and one of the FOUP and a front end of the wafer processing apparatus, the pliant member is attached to the other one of the FOUP and the front end of the processing apparatus.

9. The method of claim 8, further comprising moving the FOUP towards the front end of the wafer processing apparatus to form a seal recess in the pliant member.

10. The method of claim 8, wherein the seal is formed by deforming the pliant member to form a recessed region in the pliant member.

11. The method of claim 8, wherein the pliant member is an inflatable bladder seal.

12. The method of claim 8, wherein the pliant member comprises closed cell foam material.

13. A semiconductor processing apparatus, comprising:
a front end part having an interface opening for interfacing with a wafer cassette, the interface opening having an interface surface that surrounds the interface opening; and
a compressible member configured to mate with the interface opening and a portion of the wafer cassette, the wafer cassette defining an opening for passing wafers therethrough, the compressible member being configured to substantially deform to form a seal between the wafer cassette and the interface opening.

14. The semiconductor processing apparatus of claim 13, wherein the compressible member substantially deforms to define a compressed recess region formed in the compressible member generally having a shape similar to a portion of the wafer cassette defining the opening of the cassette.

15. The semiconductor processing apparatus of claim 13, wherein the compressible member substantially deforms to define an outer surface of the compressible member that is adapted to be moved relative the interface surface.

16. A semiconductor processing apparatus, comprising:
a front end part having an interface opening for interfacing with a closeable wafer cassette; and
a sealing recess on the front end part, the sealing recess is adapted to receive a portion of the wafer cassette to seal the wafer cassette with the interface opening.

17. The apparatus of claim 16, wherein the wafer cassette has a contact surface defining a cassette opening for passing wafers therethrough, the contact surface is configured to fit within the sealing recess, and the sealing recess is formed of pliant material.

18. The apparatus of claim 16, wherein the sealing recess is defined by a pliant sealing member that protrudes from and surrounds the interface opening.

19. A method of processing semiconductor wafers, comprising:
moving a wafer cassette into position at a front end of a wafer processing apparatus, the wafer cassette having a contact surface; and
forming a seal between the wafer cassette and the front end by fitting the contact surface of the wafer cassette into a sealing recess on the front end of the wafer processing apparatus.

20. The method of claim 19, wherein the sealing recess is defined by deformation of a pliant sealing member attached to the front end of the wafer processing apparatus.

21. The method of claim 20, wherein the sealing member protrudes from the front end of the wafer processing apparatus, and the contact surface defines a wafer cassette opening, through which wafers can be passed.

22. The method of claim 19, wherein the sealing recess is pre-formed.
